(19) United States
(12) Patent Application Publication
(10) Pub. No.: US 2003/0231510 A1
(43) Pub. Date: Dec. 18, 2003

(54) Vehicle headlamp

(76) Inventors: Yuki Tawa, Shizuoka (JP); Masaaki Ishikawa, Shizuoka (JP)

Correspondence Address: FISH & RICHARDSON P.C., 45 ROCKEFELLER PLAZA, SUITE 2800, NEW YORK, NY, 10111, US

(21) Appl. No.: 10/462,545

(22) Filed: Jun. 16, 2003

(30) Foreign Application Priority Data
Jun. 17, 2002 (JP) P.2002-175270

(51) Int. Cl. F21V 19/02

(52) U.S. Cl. 362/528; 362/523

(57) ABSTRACT

Techniques are provided to decrease load resulting from the bending of a cord when the direction of irradiation of a vehicle headlamp is changed. A vehicle headlamp 100 has a tiltable member for supporting a light source bulb 170 tiltably supported by a lamp body 110. A cord 181 led out from the light source is fixed to cord clamps 181a and 181b in the vicinity of the tiltable fulcrum supporting the tiltable member.

### CROSS REFERENCE TO RELATED APPLICATIONS

This application claims the benefit of priority from Japanese Patent Application No. 2002-175270, filed Jun. 17, 2002, which is incorporated herein by reference in its entirety.

### BACKGROUND

The present disclosure relates to a vehicle headlamp. More particularly, the present disclosure relates to the art of decreasing load resulting from the bending of a cord when the direction of irradiation is changed.

Variable light distribution type headlamps are widely used for vehicle lamps, particularly for automotive headlamps, to improve safety.

Changes of light distribution are broadly classified into two categories in concept: changing the luminous distribution pattern comes under one category and changing the direction (angle) of irradiation comes under the other.

The former is intended to change light distribution during travel in order to switch between a high beam (driving beam) and a low beam (meeting beam) depending on the driving condition; the high beam is mainly used during travel in suburbs and high-speed driving on highways, whereas the low beam is mainly used during travel in urban areas and at the time of meeting oncoming vehicles. The latter is intended to make an adjustment (an aiming adjustment or an initial aiming adjustment) of the main optical axis (irradiation axis) of a headlamp at the time of shipment from the manufacturer and of regular or irregular inspections for the vehicle body shaft, to make an (leveling) adjustment for vertically changing the direction of irradiation in accordance with the longitudinal inclination of the vehicle body due to a change in load and inertia at the time of acceleration or deceleration during travel and also to make an adjustment for laterally changing the direction of irradiation when driving on curved roads and turning to the right or left.

The direction of irradiation may be adjusted by tilting a tiltable member supporting a light source. In such a structure that a reflector with the light source mounted thereon is tiltably supported by a lamp body, the direction of irradiation is changed by making the reflector move to one side. In such a structure that a plurality of reflectors (e.g., a reflector for the high beam, a reflector for the low beam and so forth) are supported by tiltable frames with respect to lamp bodies, moreover, the direction of irradiation is changed by making the frame move to one side. When such a frame as mentioned above is employed, each reflector with the light source mounted thereon may be pivotally supported by the frame. A tiltable member for changing the direction of irradiation by making the tiltable member move to one side may additionally be provided. For example, the leveling adjustment may be made by vertically tilting the frame and the adjustment for laterally turning the direction of irradiation by tilting the reflectors may also be made when driving on curved roads and turning to the right or left.

Various cords may be used in a vehicle headlamp, including a cord for supplying electric power to a light source and a cord for supplying electric power to a drive means in such a case as to make a tiltable member move to one side by the drive means like a motor or a solenoid that is electrically driven.

When the cord is led out from a member (light source or the like) supported by the tiltable member, the cord is pulled and contracted as the tiltable member moves to one side.

### SUMMARY

The present application describes techniques related to decreasing the bending load of wires in a vehicle headlamp.

In one aspect, a vehicle headlamp includes a lamp body; a tiltable member tiltable on an axis about a fulcrum and tiltably supported by the lamp body; and a light source having a cord and supported by the tiltable member, wherein the cord from the light source is fixed in the vicinity of the fulcrum of the tiltable member.

The light source cord also may be fixed to the lamp body such that a line connecting the location where the cord is fixed to the tiltable member and the location where the cord is fixed to the lamp body is set in parallel to the axis of the tiltable member.

The tiltable member may be a reflector.

In another aspect, a vehicle headlamp includes a lamp body; a tiltable member tiltable on an axis about a fulcrum and tiltably supported by the lamp body; a light source having a cord and tiltably supported by the tiltable member; and lighting control means having a cord and tiltably coupled to the lamp body to change the direction of irradiation of light from the light source, such that all or part of the cords from the light source and the lighting control means are fixed in the vicinity of the fulcrum of the tiltable member.

The systems and techniques described here may provide one or more of the following advantages. In some implementations, there is a decreased load resulting from the bending of a cord when the direction of irradiation is changed.

Details of one or more implementations are set forth in the accompanying drawings and the description below. Other features and advantages may be apparent from the description and drawings, and from the claims.

### BRIEF DESCRIPTION OF THE DRAWINGS

These and other aspects will now be described in detail with reference to the following drawings.

[FIG. 1]

FIG. 1 is an illustration of an implementation of a vehicle headlamp with a tiltable member (reflector) that has moved to one side.

[FIG. 2]

FIG. 2 is an illustration of the vehicle headlamp of FIG. 1 where the tiltable member has moved in a direction opposite to that illustrated in FIG. 1.

[FIG. 3]

FIG. 3 is an illustration of the principal part of a vehicle headlamp as a another implementation.

[FIG. 4]

FIG. 4 is an exploded perspective view of a vehicle headlamp in accordance with the present disclosure.

[FIG. 5]

FIG. 5 is a perspective view of the principal part of the headlamp of FIG. 4 as seen from the back.

[FIG. 6]

FIG. 6 is an illustration of a prior art vehicle headlamp with a tiltable member (reflector) that has moved to one side.

[FIG. 7]

FIG. 7 is an illustration of the vehicle headlamp of FIG. 7 where the tiltable member has moved in a direction opposite to the direction of FIG. 6.

Like reference symbols in the various drawings indicate like elements.

### DETAILED DESCRIPTION

The systems and techniques described relate to a vehicle headlamp that has a tiltable member for supporting a light source tiltably supported by a lamp body and a cord led out from the light source. The cord may be fixed in the vicinity of the tiltable fulcrum, which acts as pivot point, of the tiltable member.

In an implementation, a vehicle headlamp has a light source tiltably supported by a lamp body and a tiltable member for supporting lighting control means for changing the direction of irradiation of light from the light source and the whole or part of cords led out from the light source and the lighting control means are fixed in the vicinity of the tiltable fulcrum, which acts as a pivot point, of the tiltable member.

Fixing the cord in the vicinity of the tiltable fulcrum of the tiltable member, may decrease cord movement because the cord substantially twists when the tiltable member moves to one side and the cord follows the tilting movement of the tiltable member.

An implementation of a vehicle headlamp may be provided with a tiltable member supported by a lamp body and used for supporting a light source, a cord led out from the light source being fixed in the vicinity of the tiltable fulcrum of the tiltable member.

Another implementation of a vehicle headlamp according to the present disclosure may be provided with a tiltable member supported by a lamp body and may be used to support a light source and a lighting control means for changing the direction of irradiation of light from the light source, and the whole or part of cords led out from the light source and the lighting control means are fixed in the vicinity of the tiltable fulcrum of the tiltable member.

The lamp body can be a member fixed to a vehicle body and have a hollow portion that opens substantially forward. A lens may be attached to the hollow portion so as to close the hollow portion whereby to form an outer casing having space (a lamp chamber) inside. The lens may have lens steps for refracting and/or diffusing light or may be a so-called plain lens without any lens step.

The tiltable member may be disposed within the lamp chamber. In this case, the tiltable member is a member moving to one side to change the direction of irradiation and also used to support the light source. An incandescent lamp, a discharge lamp and so on are usable as light sources.

When a reflector supporting the light source is tiltably disposed within the lamp chamber, the reflector is equivalent to the tiltable member.

There may be a case where a frame is tiltably disposed within the lamp chamber and where the reflector supporting the light source is supported by the frame. In this case, the frame is equivalent to a tiltable member, so that the tiltable member (frame) supports the light source indirectly (using the reflector). Consequently, supporting a light source may include supporting the light source directly and also indirectly.

When a frame is employed, the reflector may tiltably be supported by the frame. In such a case as this, not only the reflector but also the frame is a tiltable member.

Although there may be a case where the reflector and the frame are tiltably supported by a member fixed to the lamp chamber (a fixed member), the fixed member may be considered as a part of the lamp body.

There may also be a case where the reflector and the frame (tiltable members) are moved to one side by a drive portion driven automatically or under remote control. The drive portion may be considered as part of the lighting control means.

A reflector having a converging function may be used and a shade for limiting the upper edge of a luminous distribution pattern may be disposed in the converging area of the reflector, so that a plurality of luminous distribution patterns different in the position and configuration of the upper edge are obtained by moving the shade. With this arrangement employed, the drive portion for moving the shade may be considered as part of the lighting control means.

The source of driving power of each drive portion (lighting control means) above is not limited to a specific one but may be a motor, a solenoid, an air cylinder or the like.

The automatic driving of the drive portion (lighting control means) may include a drive portion that is automatically driven on the basis of the results detected properly by a sensor and also that when the longitudinal inclination of a vehicle body is detected by a position sensor provided, for example, between axles in front and behind and the vehicle body. Light distribution may be turned downward or upward to compensate for the inclination. Further, the automatic driving of the drive portion may include detecting a steering operation and its direction by, for example, a sensor for detecting the steering operation. Light distribution may be turned to the right or left to compensate for a change in direction. The remote control of the drive portion (lighting control means) may include that the driver in the driver's seat can operate an operating portion in harmony with driving or vehicle conditions.

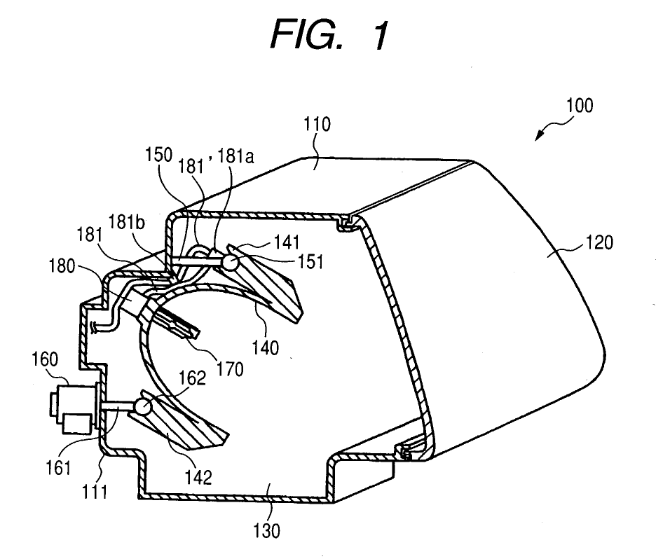

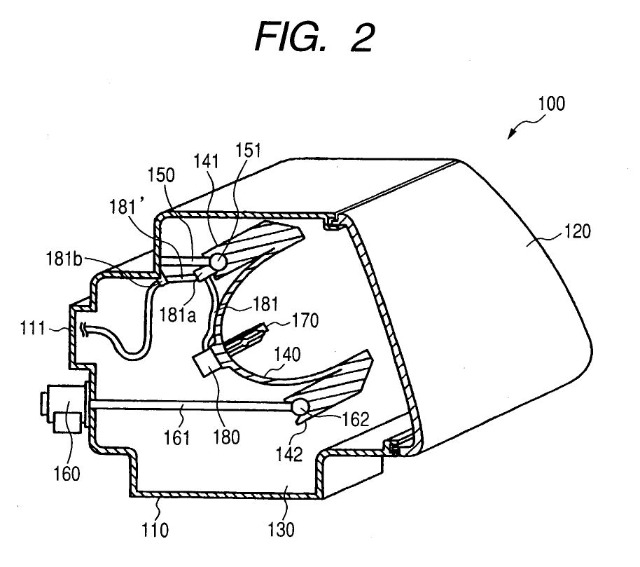

Referring to FIGS. 1 and 2, an implementation of a vehicle headlamp 100 is an automotive headlamp. A lens 120 may be attached to a lamp body 110 having a hollow portion that opens substantially forward to cover the front opening in order to demarcate a lamp chamber 130. Further, a reflector 140 may be tiltably disposed within the lamp chamber 130. Although the reflector 140 can be provided so that it is capable of moving so as to tilt vertically and laterally, only the vertically tilting movement is referred to in this case.

A fulcrum shaft 150 may be supported by the upper portion of the rear wall surface 111 of the lamp body 110. A bearing 151 may be formed integrally with the front end of the fulcrum shaft 150 and the bearing 151 can be rotatably fitted into a bearing receiving portion 141 formed so as to project backward in the upper end portion of the reflector 140, the bearing 151 being used as a tiltable fulcrum.

A leveling drive portion 160 may be supported by the lower end portion of the rear wall surface 111 of the lamp body 110. The leveling drive portion 160 can have a driving source such as a motor to be driven automatically or under remote control inside and an adjusting rod 161 projected from the front end of the leveling drive portion 160 is moved back and forth when the driving source is driven. A bearing 162 may be formed integrally with the front end of the adjusting rod 161. The bearing 162 can be rotatably fitted into a bearing receiving portion 142 formed so as to project backward in the lower end portion of the reflector 140, whereby the lower end portion of the reflector 140 is coupled to the leveling drive portion 160.

A bulb 170 as a light source is supported by the reflector 140. The bulb 170 is a discharge bulb, for example, and a power supply socket 180 is attached to a base portion projecting from the rear side of the reflector 140.

A cord 181 is led out from the power supply socket 180 before being drawn out from the center of the rear portion of the lamp body 110. Further, the cord 181 is fixed to two cord clamps including a cord clamp 181a near a bearing receiving portion 141 on the upper side of the reflector 140 and a cord clamp 181b near a place where the fulcrum shaft 150 of the lamp body 110 is supported. In other words, the cord 181 is secured in the vicinity of the tiltable fulcrum 151. In this case, the length between the two cord clamps 181a and 181b of the cord 181 is substantially great enough to prevent the tilting of the reflector 140 (the tilting of the reflector from the state shown in FIG. 1 to what is shown in FIG. 2) from being impeded.

In the vehicle headlamp 100 above, since the cord 181 drawn out from the light source (bulb) 170 is fixed by the cord clamps 181a and 181b near the tiltable fulcrum 151 of the reflector 140, part of the cord 181 moves as the reflector 140 moves to one side and only the portion 181′ between the cord clamps 181a and 181b is moved then. Moreover, the moving amount at this time is extremely small because the reflector 140 is allowed to move to one side by substantially twisting the portion 181′ of the cord 181. Therefore, the load applied to the leveling drive portion 160 by the bending of the cord 181 is extremely small.

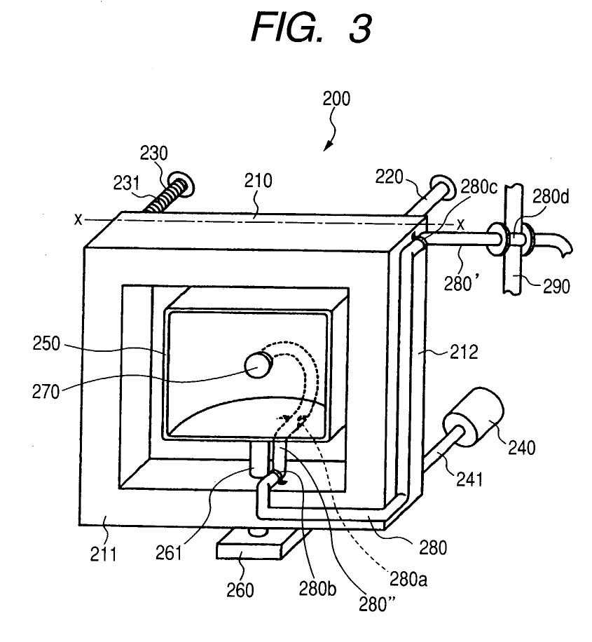

FIG. 3 shows the principal part of a vehicle headlamp as a second implementation of the disclosure.

A vehicle headlamp 200 is an automotive headlamp and provided with a frame 210 tiltably disposed in a lamp chamber

The frame 210 may be tiltably supported by a pivotal shaft 220, an adjusting shaft 230 and a leveling drive portion 240 within the lamp body.

The fulcrum shaft 220 may include a bearing (not shown) integrally formed at the front end, the bearing being rotatably fitted into the frame 210.

The adjusting shaft 230 may be rotatably supported by the lamp body and a threaded shaft portion 231 can be screwed into a nut body (not shown) supported by the frame 210.

The frame 210 may be coupled to the leveling drive portion 240 below a position where the bearing of a tiltable fulcrum, that is, the fulcrum shaft 220 is fitted in. The leveling drive portion 240 may include a driving source such as a motor to be driven automatically or under remote control inside and an adjusting rod 241 projected from the front end that may be moved back and forth when the driving source is driven. A bearing (not shown) formed integrally with the front end of the adjusting rod 241 may be rotatably fitted into the frame 210. When the leveling drive portion 240 is driven, the frame 210 moves so as to vertically tilt with a line connecting the coupling point of the fulcrum shaft 220 (the position of the bearing) and the coupling point of the adjusting shaft 230 (the position of the nut body) as a tilting axis x. The adjusting shaft 230 is used to move the frame 210 to one side at the time of initial aiming and the adjusting shaft 230 is turned, the threaded shaft portion 231 is screwed into the nut body supported by the frame or screwed back. As the adjusting shaft 230 is not moved back and forth with respect to the lamp body, the portion used to support the nut body of the frame 210 is moved back or forth. Therefore, the frame 210 moves so as to laterally tilt with the line connecting the coupling point of the fulcrum shaft 220 (the position of the bearing) and the coupling point of the leveling drive portion 240 as an axis when the adjusting shaft 230 is rotated.

A reflector 250 may be laterally tiltably supported by the frame 210. A swivel drive portion 260 may be supported substantially at the center of the lower end portion of the frame 210. The swivel drive portion 260 can be used to move the reflector 250 so as to tilt with respect to the frame 210 and has a rotary shaft 261 automatically rotated in response to steering operation. The rotary shaft 261 is passed upward through the lower side portion 211 of the frame 210 and the reflector 250 is supported by the portion projected upward from the lower side portion 211. Therefore, the reflector 250 moves so as to laterally tilt when the swivel drive portion 260 is driven.

In an implementation, an incandescent bulb 270 may be supported by the reflector 250 and a cord 280 for use in supplying power is extended from the incandescent bulb 270. The cord 280 is trained against the back and then the base of the reflector 250 before being fixed to a cord clamp 280a near the rotary shaft 261 of the swivel drive portion 260 and in the base of the reflector 250. Further, the cord 280 is extended along the rotary shaft 261 and fixed to a cord clamp 280b near the position where the rotary shaft 261 of the swivel drive portion 160 is passed through the top surface of the lower side portion 211 of the frame 210. The cord 280 is trained against the front of the lower side portion 211 of the frame 210 from the cord clamp 280b and then the outer side of one side portion 212 before being fixed to a cord clamp 280c near the position where the bearing (not shown) of the fulcrum shaft 220 is fitted in the outer side of the one side portion 212. A cord fixing portion 290 is provided to the lamp body (not shown) and the cord 280 parting from the cord clamp 280c is fixed to the cord fixing portion 290. A cord 280′ in the portion between a point 280d fixed to the cord fixing portion 290 of the cord 280 and the cord clamp 280c extends in substantially parallel to the tilting axis x.

In a case where the frame 210 moves so as to vertically tilt when the leveling drive portion 240 is driven, the cord 280 allows the frame 210 to move to one side by mainly causing the portion 280′ between the cord clamp 280c and the fixed point 280d to twist. In a case where the reflector 250 moves so as to laterally tilt when the swivel drive portion 260 is driven, the cord 280 allows the reflector 250 to move to one side by mainly causing the portion 280″ between the cord clamps 280a and 280b to twist. When the frame 210 and the reflector 250 as tiltable members move to one side, the load applied to the leveling drive portion 240 and the swivel drive portion 260 as lighting control means becomes extremely small as only the short portions 280′ and 280″ of the cord 280 are substantially twisted.

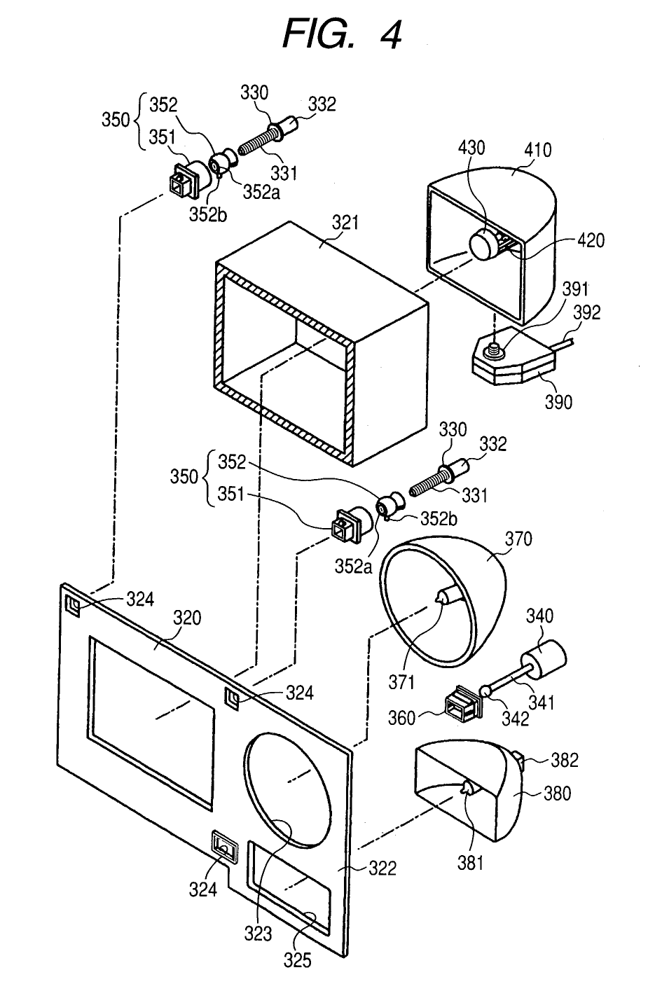

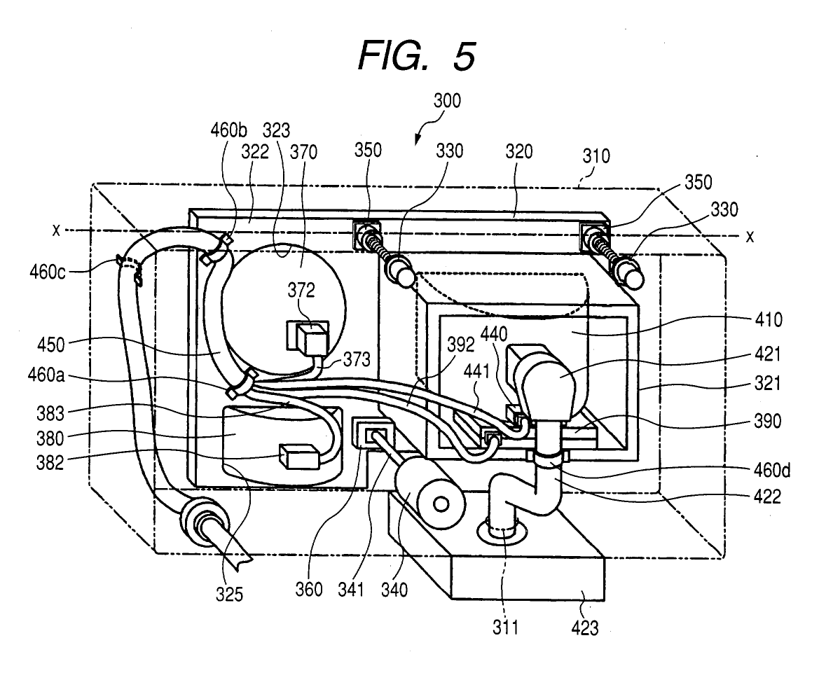

FIGS. 4 and 5 show another implementation of a vehicle headlamp.

A vehicle headlamp 300, though not shown in detail, has an outer casing 310 formed with a lamp body and a lens, and a frame 320 is tiltably disposed within the outer casing 310.

The frame 320 is substantially rectangular in front shape, which is long sideways such that one side portion of a framelike portion 321 having a length longitudinally and a substantially platelike support portion 322 are provided integrally in a connected row arrangement. Two openings 323 and 325 are formed vertically in parallel in the support portion 322. A mounting hole is formed in three places 324, 324 and 324 of the frame 320, respectively corresponding to both L-shaped sides and a bending point as seen from the longitudinal direction.

The frame 320 is tiltably supported by the lamp body via two adjusting shafts 330 and 330 and a leveling drive portion 340.

Each of the adjusting shafts 330 is formed integrally with a threaded shaft portion 331 and an operating head 332 provided at the rear end of the threaded shaft portion 331 and rotatably supported by the rear wall surface of the lamp body. The adjusting shaft 330 is coupled to the frame 320 via a nut member 350.

The nut member 350 includes a nut receiving body 351 and a nut body 352. The nut receiving body 351 is formed of synthetic resin and a spherical hollow portion (not shown) having an opening at the rear end is formed. The nut body 352 is supported by the nut receiving body 351. The nut body 352 is spherical in outer form and has a threaded hole 352a passed through the center of the nut body 352 and a mating pin 352b projecting from the outer peripheral face in the diametrical direction. The nut body 352 is rotatably fitted in the spherical hollow portion of the nut receiving body 351 and the mating pin 352b slidably mates with a slide groove formed in the spherical hollow portion (not shown) of the nut receiving body 351 in such a manner as to longitudinally extend.

The nut members 350 and 350 are supported by the respective two mounting holes 324 and 324 on the upper side of the frame 320. Moreover, the threaded shaft portions 331 and 331 of the two adjusting shafts 330 and 330 are respectively screwed into the threaded holes 352a and 352a of the nut bodies 352 and 352 of the nut members 350 and 350. Consequently, the threaded shaft portions 331 and 331 are screwed into the nut bodies 352 and 352 by rotating the adjusting shafts 330 and 330. As the adjusting shafts 330 and 330 are set longitudinally unmovable with respect to the lamp body, the portions used to support the nut members 350 and 350 of the frame 320 are moved back and forth. Further, as the nut receiving bodies 352 and 352 supported by the frame 320 are rotatably, these nut bodies 352 and 352 form the tiltable fulcrums of the frame 320.

A bearing receiving body 360 is supported by the mounting hole 324 on the lower side of the frame 320. The bearing receiving body 360 is formed of synthetic resin and a spherical hollow portion (not shown) having an opening at the rear end is formed.

The leveling drive portion 340 has a driving source such as a motor to be driven automatically or under remote control inside and an adjusting rod 341 projected from the front end is moved back and forth when the driving source is driven. A bearing 342 formed at the front end of the adjusting rod 341 is fitted into the frame 210. When the leveling drive portion 240 is driven, the frame 320 moves so as to vertically tilt with a line connecting the two nut bodies 352 and 352 as a tilting axis x.

A reflector 370 is supported by the upper portion of the support portion 322 and another reflector 380 is supported by the lower portion of the support portion 322. Bulbs 371 and 381 are supported by the respective reflectors 370 and 380. In this case, the reflectors 370 and 380 excluding their front end portions are projected back from the openings 323 and 325.

Then the reflector 370 and the bulb 371 are used to form a headlamp for a high-beam unit and the reflector 380 and the bulb 381 are used to form a fog lamp unit.

A reflector 410 are supported by the framelike portion 321 so as to laterally tilt via a swivel drive portion 390. The swivel drive portion 390 is used to make the reflector 410 move so as to laterally tilt with respect to the frame 320 and provided with a rotary shaft 391 automatically rotating in response to the steering operation performed, the rotary shaft 391 being connected to the back of the reflector 410. Therefore, the reflector 410 moves so as to laterally tilt when the swivel drive portion 390 is driven.

The reflector 410 employs a discharge bulb as a light source and the upper edge of a luminous distribution pattern is limited by a shade 430 disposed in the light converging position of the discharge bulb 420 and moreover two different luminous distribution patterns are obtained by vertically moving the shade 430. Accordingly, an actuator 440 is attached to the reflector 410 and the actuator 440 is so arranged as to select one of the two position of the shade 430 by turning a solenoid on/off.

A low-beam headlamp unit is formed with the reflector 410, and discharge bulb 420 and the shade 430.

A cord 373 led out from a connector 372 attached to the base portion of the bulb 371 fitted to the reflector 370, a cord 383 led out from the connector 382 of the bulb 381 fitted to the reflector 380, a cord 392 led out from the swivel drive portion 390 and a cord 441 led out from the actuator 440 are brought together in one bundle. The bundle of cords 450 is fixed by a fixing metal part 460a on the underside of the opening 323 out of the back of the support portion 322 of the frame 320. The bundle of cords 450 is fixed by a fixing metal part 460b in a position close to the tiltable axis x out of the upper end portion of the back of the support portion 322. Further, the bundle of cords 450 is hung on a hanging metal part 460c provided near the tilting axis x of the lamp body and led outside the outer casing 310. Consequently, a portion 450′ between the fixing metal part 460b and the hanging metal part 460c out of the bundle of cords 450 is allowed to extend in substantially parallel to the tilting axis x.

A power supply cord 422 led out from a power supply socket 421 attached to the base of the discharge bulb 420 mounted onto the reflector 410 is fixed by a fixing metal part 460d at the rear end of the lower end portion of the framelike portion 321 of the frame 320. Moreover, the power supply cord 422 is passed through a through-hole 311 formed in the extended position of the rotary shaft 391 of the swivel drive portion 390 out of the base portion of the outer casing 310.

In the vehicle headlamp 300, the frame 320 moves so as to vertically tilt on the tilting axis x. At this time, the bundle of cords 450 allows the frame 320 to move to one side as the portion 450′ (a portion in substantially parallel to the tilting axis x) between the fixing metal part 460b and the hanging metal part 460c substantially twists. Consequently, the cords 373, 383, 392 and 441 cause almost no load to be applied to the leveling drive portion 340.

When the swivel drive portion 390 is driven, the reflector 410 moves so as to laterally tilt. Since the power supply cord 422 extends in substantially parallel to the tiltable shaft, that is, in the vicinity of the rotary shaft 391 of the swivel drive portion 390 of the reflector 410, the power supply cord 422 allows the reflector 410 to move to one side by twisting and the power supply cord 422 causes almost no load to be applied to the swivel drive portion 390.

An implementation of the headlamp has the tiltable member for supporting the light source tiltably supported by the lamp body and the cord led out from the light source is fixed in the vicinity of the tiltable fulcrum of the tiltable member.

In another implementation of a vehicle headlamp, because the cord is fixed in the vicinity of the tiltable fulcrum of the tiltable member, the moving amount of the cord is small when the tiltable member moves to one side and the cord follows the tilting movement of the tiltable member by substantially twisting. Therefore, the cord causes almost no load to be applied to the tiltable member.

Another implementation of a vehicle headlamp has the tiltable member for supporting the lighting control means for changing the direction of irradiation of light from the light source and the whole or part of cords led out from the light source and the lighting control means are fixed in the vicinity of the tiltable fulcrum of the tiltable member.

In another implementation of the headlamp, because the cords are fixed in the vicinity of the tiltable fulcrum of the tiltable member, the moving amount of the cords may be small when the tiltable member moves to one side and the cord follows the tilting movement of the tiltable member by substantially twisting. Therefore, the load applied to the cords as the tiltable member moves to one side is reduced as compared to when the cord is not fixed near the tiltable fulcrum.

Cords from the light source and/or the lighting control means may be fixed to the lamp body such that a line connecting the position where the cord is fixed to the tiltable member and the position where the cord is fixed to the lamp body is set in parallel to the tilting axis of the tiltable member, which may further reduce the load applied to the cord as the tiltable member moves to one side.

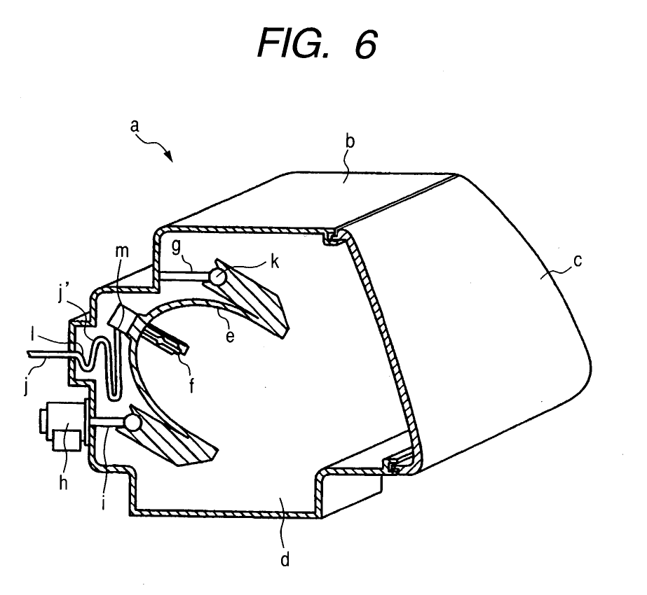

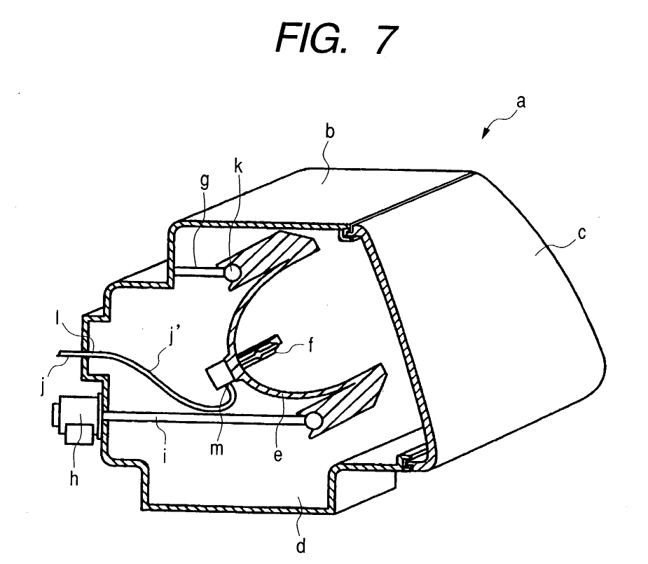

FIGS. 6 and 7 show an example of a conventional vehicle headlamp a.

The vehicle headlamp a is provided with a lamp body b and the front opening of the lamp body b is covered with a lens c to demarcate a lamp chamber d. A reflector e is tiltably provided within the lamp chamber d and a bulb f is mounted on the reflector e as a light source.

The upper end portion of the reflector e is pivotally supported by the lamp body b using a fulcrum shaft 9 and the lower end portion of the reflector e is coupled to a leveling drive portion h. The leveling drive portion h is driven under remote control or automatically and has an adjusting rod i moving back and forth. The front end of the adjusting rod i is coupled to the lower end portion of the reflector e.

A cord j for use in supplying power to the bulb f is fixed to the lamp body b. The cord j includes a portion j′ (see FIG. 7) between the portion fixed to the lamp body b and the bulb f so that the portion j′ warps and provides slack when the reflector e moves so as to tilt upward.

In the case of the vehicle headlamp a above, the reflector e is pivoted downward with a point k coupled to the fulcrum shaft g. Point k acts as a fulcrum, or pivot point, when the adjusting rod i of the leveling drive portion h moves back (see FIG. 6). When the adjusting rod i moves forward conversely, the reflector e is pivoted upward (see FIG. 7), whereby the direction of irradiation is turned upward.

In the case of the conventional vehicle headlamp a, the position where the cord j is fixed to the lamp body b has been chosen at random, that is, without considering the positional relation between the reflector (tiltable member) e and a tilting axis. Consequently, the varying amount of the distance between two terminals l (the terminal fixed to the lamp body b) and m (the point coupled to the bulb f) of the cord j at either terminal of the pivotal range tends to increase. When the distance between the two terminals l and m becomes shortest, the cord j becomes bent at an acute angle, whereas when the distance between the two terminals l and m becomes longest, the cord j is substantially straightened. Therefore, a greater load based on the bending strength of the cord j is applied to the leveling drive portion h for making the reflector e move to one side. A greater burden may be imposed on the leveling drive portion h; in other words, the longer the distance that stretches from the fulcrum k up to the terminal m on the moving side of the cord j as a point of application, the greater the generated moment in the cord j having the same bending strength becomes. Thus, the load applied to the leveling drive portion h may be increased.

With the distance between the two terminals l and m of the cord j shortened, the cord j is in such a condition as to coil on itself and since the distance between the two terminals l and m is long, the movement of the cord j is difficult to foresee and the cord j may interfere with other component parts.

As vehicle headlamps are equipped with drive portions other than those for use in leveling adjustment in addition to multi-lamp systems, the tendency may be for the number of cords led out from tiltable members to increase. Therefore, the load corresponding to power to move the tiltable members to one side may become greater. The power to drive leveling portions and so on tends to become greater when the tiltable members, like reflectors, move to one side. Consequently, it may be more difficult to move the tiltable members to one side for leveling adjusting purposes.

The specific configurations of the parts as well as the structure thereof shown in the above embodiments of the disclosure solely represent specific examples for implementing the disclosure and it is intended that the technical scope of the disclosure shall be interpreted as illustrative and not in a limiting sense.

Other embodiments may be within the scope of the following claims. disclosure

What is claimed is:

1. A vehicle headlamp having a tiltable member tiltable about a fulcrum for supporting a light source tiltably supported by a lamp body, wherein
a cord led out from the light source is fixed in the vicinity of the fulcrum of the tiltable member.

2. A vehicle headlamp having a light source tiltably supported by a lamp body and a tiltable member tiltable about a fulcrum for supporting lighting control means for changing the direction of irradiation of light from the light source, wherein
the whole or part of cords led out from the light source and the lighting control means are fixed in the vicinity of the fulcrum of the tiltable member.

3. A vehicle headlamp as claimed in claim 1, wherein a line connecting a position where the cord is fixed to the tiltable member and a position where the cord is fixed to the lamp body is set in parallel to a tilting axis of the tiltable member.

4. A vehicle headlamp as claimed in claim 2, wherein a line connecting a position where the cord is fixed to the tiltable member and a position where the cord is fixed to the lamp body is set in parallel to a tilting axis of the tiltable member.

5. A vehicle headlamp comprising
a lamp body;
a tiltable member tiltable on an axis about a fulcrum and tiltably supported by the lamp body; and
a light source having a cord and supported by the tiltable member,
wherein the cord from the light source is fixed in the vicinity of the fulcrum of the tiltable member.

6. The vehicle headlamp of claim 5, wherein the cord is fixed to the lamp body and wherein a line connecting the location where the cord is fixed to the tiltable member and the location where the cord is fixed to the lamp body is set in parallel to the axis of the tiltable member.

7. The vehicle headlamp of claim 6 wherein the tiltable member comprises a reflector.

8. The vehicle headlamp of claim 4 wherein the tiltable member comprises a reflector.
